(19) United States
(12) Patent Application Publication
(10) Pub. No.: US 2012/0103000 A1
(43) Pub. Date: May 3, 2012

(54) DISPENSER RECESS WITH LIGHT PIPE AND REFRIGERATION APPLIANCE INCORPORATING SAME

(75) Inventors: Andrew Reinhard Krause, LaGrange, KY (US); David Duane Warmuth, Louisville, KY (US); Christopher George Bissig, Louisville, KY (US); Justin Tyler Brown, Louisville, KY (US); David C. Calvert, Mount Sterling, KY (US); Jarvis Ward, Louisville, KY (US); Jose Tomas DeLuna, Allen Park, MI (US)

(73) Assignee: GENERAL ELECTRIC COMPANY, Schenectady, NY (US)

(21) Appl. No.: 12/917,713

(22) Filed: Nov. 2, 2010

(51) Int. Cl. F25D 3/00; F21V 33/00; G02B 6/00; B67D 7/86

(52) U.S. Cl. 62/389; 222/113; 362/96; 362/551

(57) ABSTRACT

An illuminated dispenser assembly may include a dispenser recess area defined by walls, such as a bottom wall, two side walls, a back wall and a top wall. A dispenser has an outlet extending through one of the walls of the dispenser recess area to dispense a substance from an interior area to the dispenser recess via the outlet. A lighting element is located for illuminating the dispenser recess. The lighting element includes at least one light source and at least one light pipe for transmitting light from the light source to the dispenser recess. The light source may be placed in different states and/or may illuminate with different colors depending on status, user selection, time of day, etc.

### FIELD OF THE INVENTION

The subject matter disclosed herein relates generally to a lighted dispenser recess, such as those found in consumer appliances, including refrigeration appliances.

### BACKGROUND OF THE INVENTION

Dispensers for liquids or ice have been provided in refrigeration appliances such as refrigerators, freezers, and vending machines. In certain of such devices, both hot and cold water may be provided. In some devices, coffee or other beverages may be dispensed as well. Often, these dispensers include some sort of recess or compartment into which a container such as a cup is placed to receive the substance.

Lighting may be provided for the compartment to assist the user in placing the container so as to receive the substance. Typically, such lighting is an incandescent bulb placed in a top portion of the compartment. While such a bulb will generally illuminate the compartment sufficiently, such a bulb can not provide much information to a user. Also, aesthetically, such a bulb is somewhat limited.

Accordingly, improved lighting devices and systems for dispenser recesses would be welcome.

### BRIEF DESCRIPTION OF THE INVENTION

Aspects and advantages of the invention will be set forth in part in the following description, or may be obvious from the description, or may be learned through practice of the invention.

According to certain aspects of the disclosure, an illuminated dispenser assembly is disclosed for a consumer appliance panel, the assembly including a dispenser recess area located in the panel. The dispenser recess area is defined by walls including a bottom wall, two side walls, a back wall and a top wall. A dispenser is located in the panel. The dispenser has an outlet extending through one of the walls of the dispenser recess area to dispense a substance from an interior of the consumer appliance to the dispenser recess via the outlet. A lighting element is located in the panel for illuminating the dispenser recess. The lighting element includes at least one light source and at least one light pipe for transmitting light from the light source to the dispenser recess. Various options and modifications are possible.

According to other aspects of the disclosure, an illuminated hot and cold water dispenser assembly is disclosed for an appliance door, the assembly including a dispenser recess area located in the door. The dispenser recess area is defined by walls including a bottom wall, two side walls, a back wall and a top wall. A dispenser is located in the door. The dispenser has an outlet extending through one of the walls of the dispenser recess area to dispense a substance from an interior of the door to the dispenser recess via the outlet. A lighting element is located in the door for illuminating the dispenser recess. The lighting element includes at least one light source and at least one light pipe for transmitting light from the light source to the dispenser recess. A controller illuminates the light source in either a first color or a second color. The first color corresponds to a first temperature of the dispensed substance and the second color corresponds to a second color of the dispensed substance. As above, various options and modifications are possible.

According to other aspects of the disclosure, a refrigeration appliance includes a refrigerated compartment having a door and a dispenser recess area located in the door. The dispenser recess area is defined by walls including a bottom wall, two side walls, a back wall and a top wall. A dispenser is located in the door. The dispenser has an outlet extending through one of the walls of the dispenser recess area to dispense a substance from an interior of the door to the dispenser recess via the outlet. A lighting element is located in the door for illuminating the dispenser recess. The lighting element includes at least one light source and at least one light pipe for transmitting light from the light source to the dispenser recess. Again, various options and modifications are possible.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front view of a refrigeration appliance with its doors closed;

FIG. 2 provides a front view of the refrigeration appliance of FIG. 1 with its doors opened;

FIG. 3 provides a close up view of a dispenser portion of the refrigeration appliance of FIG. 1;

FIG. 4 provides a view as in FIG. 3, with a receptacle on a bottom wall of a dispenser recess for receiving a substance from an outlet while the dispenser recess is illuminated; and

FIG. 5 provides a partial cross-sectional view of the interior of the dispensing recess taken along line 5-5 in FIG. 3 showing details of a lighting element.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

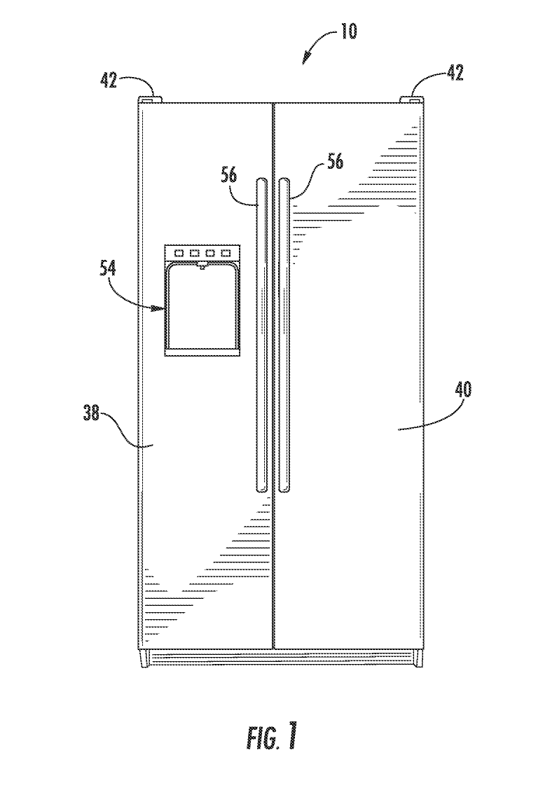

FIG. 1 is a perspective view of an exemplary refrigeration appliance 10 depicted as a refrigerator in which ice-making assemblies in accordance with aspects of the present invention may be utilized. It should be appreciated that the appliance of FIG. 1 is for illustrative purposes only and that the present invention is not limited to any particular type, style, or configuration of dispensing appliance or refrigeration appliance, and that such appliance may include any manner of refrigerator, freezer, refrigerator/freezer combination, and so forth.

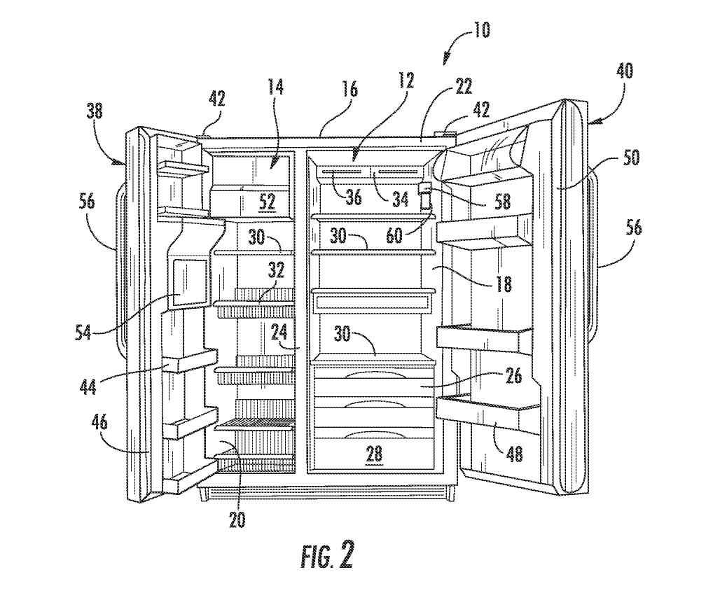

Referring to FIG. 2, the refrigerator 10 includes a fresh food storage compartment 12 and a freezer storage compartment 14, with the compartments arranged side-by-side and contained within an outer case 16 and inner liners 18 and 20 generally molded from a suitable plastic material. In smaller refrigerators 10, a single liner is formed and a mullion spans between opposite sides of the liner to divide it into a freezer storage compartment and a fresh food storage compartment. The outer case 16 is normally formed by folding a sheet of a suitable material, such as pre-painted steel, into an inverted U-shape to form top and side walls of the outer case 16. A bottom wall of the outer case 16 normally is formed separately and attached to the case side walls and to a bottom frame that provides support for refrigerator 10.

A breaker strip 22 extends between a case front flange and outer front edges of inner liners 18 and 20. The breaker strip 22 is formed from a suitable resilient material, such as an extruded acrylo-butadiene-styrene based material (commonly referred to as ABS). The insulation in the space between inner liners 18 and 20 is covered by another strip of suitable resilient material, which also commonly is referred to as a mullion 24 and may be formed of an extruded ABS material. Breaker strip 22 and mullion 24 form a front face, and extend completely around inner peripheral edges of the outer case 16 and vertically between inner liners 18 and 20.

Slide-out drawers 26, a storage bin 28 and shelves 30 are normally provided in fresh food storage compartment 12 to support items being stored therein. In addition, at least one shelf 30 and at least one wire basket 32 are also provided in freezer storage compartment 14.

The refrigerator features are controlled by a controller 34 according to user preference via manipulation of a control interface 36 mounted in an upper region of fresh food storage compartment 12 and coupled to the controller 34. As used herein, the term “controller” is not limited to just those integrated circuits referred to in the art as microprocessor, but broadly refers to computers, processors, microcontrollers, microcomputers, programmable logic controllers, application specific integrated circuits, and other programmable circuits, and these terms are used interchangeably herein.

A freezer door 38 and a fresh food door 40 close access openings to freezer storage compartment 14 and fresh food storage compartment 12. Each door 38, 40 is mounted by a top hinge 42 and a bottom hinge (not shown) to rotate about its outer vertical edge between an open position, as shown in FIG. 1, and a closed position. The freezer door 38 may include a plurality of storage shelves 44 and a sealing gasket 46, and fresh food door 40 also includes a plurality of storage shelves 48 and a sealing gasket 50.

The freezer storage compartment 14 may include an automatic ice maker 52 and a dispenser 54 provided in the freezer door 38 such that ice and/or chilled water can be dispensed without opening the freezer door 38, as is well known in the art. Doors 38 and 40 may be opened by handles 56 is conventional. A housing 58 may hold a water filter 60 used to filter water for the ice maker 52 and/or dispenser 54.

As with known refrigerators, the refrigerator 10 also includes a machinery compartment (not shown) that at least partially contains components for executing a known vapor compression cycle for cooling air. The components include a compressor, a condenser, an expansion device, and an evaporator connected in series as a loop and charged with a refrigerant. The evaporator is a type of heat exchanger which transfers heat from air passing over the evaporator to the refrigerant flowing through the evaporator, thereby causing the refrigerant to vaporize. The cooled air is used to refrigerate one or more refrigerator or freezer compartments via fans. Also, a cooling loop can be added to directly cool the ice maker to form ice cubes, and a heating loop can be added to help remove ice from the ice maker. Collectively, the vapor compression cycle components in a refrigeration circuit, associated fans, and associated compartments are conventionally referred to as a sealed system. The construction and operation of the sealed system are well known to those skilled in the art.

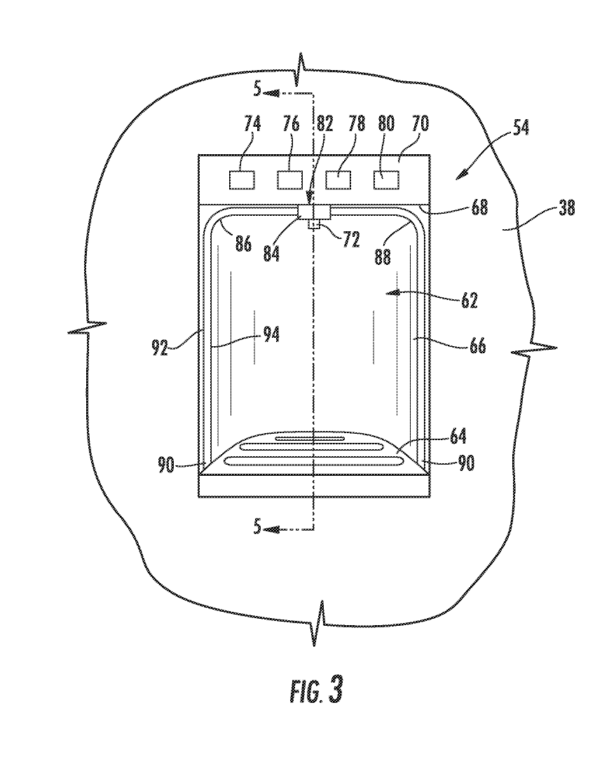

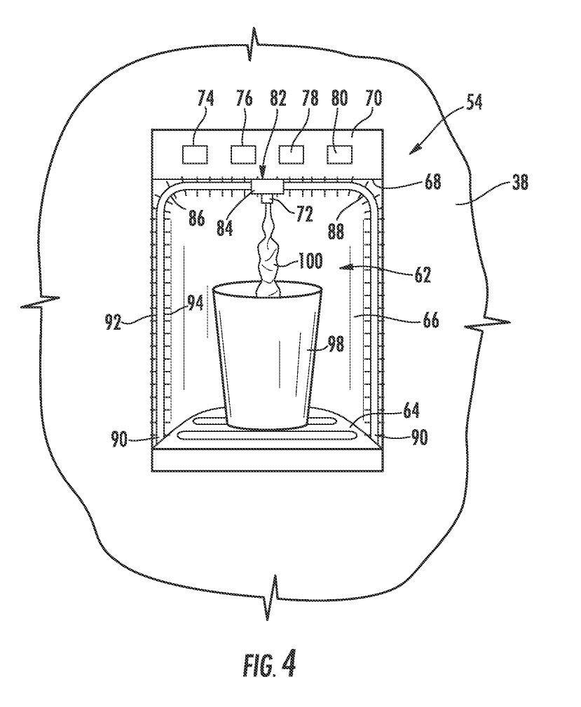

FIGS. 3 and 4 show details of one example of a dispenser 54 suitable for use on a consumer appliance of any sort, such as refrigeration appliance 10. Dispenser 54 could also be used in a device such as a vending machine, cafeteria, home, office, etc. Therefore, in its broadest sense, dispenser 54 can be employed in various locations, and certainly not just on a typical home refrigerator or the like.

As shown therein, a dispenser recess area 62 is defined in door 38. Dispenser recess 62 includes a bottom wall 64, a back wall 66, and a top wall 68. As shown, back wall 66 is curved, forming a somewhat partial cylindrical surface. It should be understood that any back wall shape and profile, including multiple walls (two sides and a back, for example) could be employed. Further, top wall 68 may be partial, covered by or constituting a façade 70, for example. Therefore, the number and orientation of walls forming dispenser recess 62 is not limiting.

At least one dispenser outlet 72 extends into dispenser recess 62 for dispensing a substance from an interior of door 38. Multiple of such dispenser outlets could be provided if desired, either separated or adjacent. The dispenser outlet or outlets 72 may dispense ice cubes, ground ice cubes, chilled water, warm water, hot water, etc. If dispenser 54 is in a device other than a refrigeration appliance, the outlets may dispense food or drink, or any other item.

One or more buttons, pressure sensitive tabs, etc. are provided around dispenser recess for controlling what is dispensed. As shown, four buttons 74,76,78,80 are provided on top wall portion 70. Each button may be labeled so as to provide an indication of what would be dispensed by pushing that button, and various options are possible, as mentioned above.

A lighting element 82 is attached to door 38 via a housing 84 which could be part of or attached to top wall 68, wall façade portion 70, etc. Housing 84 holds a portion of at least one conventional light pipe 86. As seen, two light pipes, 86,88 are provided, each having a first end (not visible) located within housing 84 and a second end 90 located at a bottom side portion of wall 66. If desired, a single light pipe could be employed extending between ends 90. Light pipes 86,88 are held within a complimentary recess formed into wall 66 by recess edges 92,94, for example by a snap fit, overmolding, or other attachment method. At least one light source 96, such as one or more LED's, OLED's, bulb's, etc. are located so that light from the light source is transmitted to light pipes 86,88. There could be multiple different-colored LED's in one location for example, or light sources in different locations if desired. It would be also possible to position light source 96 and housing 84 at one of the ends 90 rather than the top center of recess 62, and to use a single light pipe 86 or 88 if desired.

By pressing a given button 74-80, a user makes a selection as to what is to be dispensed from the one or more outlets 72. The user places a container such as cup 98 within recess 62 to receive the dispensed substance 100. When the button is pressed, either a certain premeasured amount of dispensed substance is dispensed or the substance is dispensed for a period of time based on how long the user pressed the button. For example, dispensing may start immediately or after one or two seconds of pressing a button, and then stop upon releasing the button or reaching a predetermined amount. Any such dispensing scheme is within the scope of the present invention.

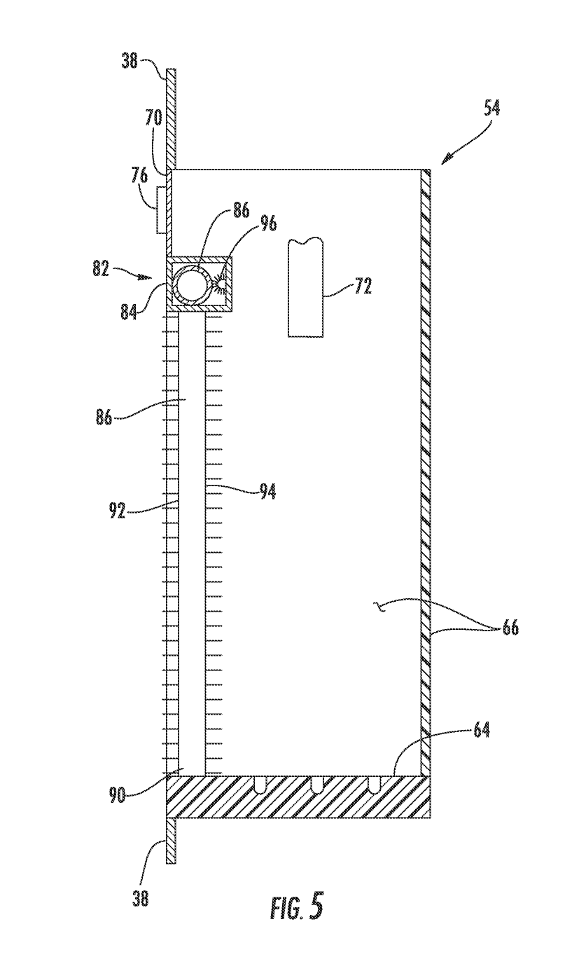

When the user presses the desired button, light source 96 is illuminated. A controller such as controller 34 or a separate controller may be in electrical communication with the buttons, light source(s) 96, and the dispenser portions upstream of outlet 72. Accordingly, light source 96 is illuminated when a button is pressed, thereby causing light pipe or pipes 86 and 88 to be illuminated as well, as shown in FIGS. 4 and 5. If desired, conventional lenses, prisms, etc. (not shown) may be employed within housing 84 to assist in directing light from light source 96 to light pipes 86,88. The light pipes may provide sufficient illumination to assist a user in using the dispensing recess. Objects considered light pipes here include light sources available from companies such as 3M under the trade names Precision Lighting Element or Light String, or other companies. Light pipes receive light from a light source and transmit the light along their length in either a tube or rod form. Light pipes may be straight, permanently bent, or flexibly bendable. Therefore, a particular type or source of light pipe should not be considered limiting or required under the invention.

If desired, light pipes 86,88 may be illuminated with different colors or in different ways. For example, if cold liquid or ice is being dispensed, a white or blue color could be displayed, whereas if a warm or hot liquid is being dispensed, a red color could be displayed. Alternatively, the light pipes could light intermittently, if desired. Also, the light pipes could be lit with a dimmer, night light and then be brighter when dispensing is desired. Therefore, various colors, brightnesses and durations of lighting could be chosen as desired. Colors could be determined by using as light source 96 multicolor LED's, multiple LED's of differing color, an LCD, or other colored or variable bulbs, etc. The controls and connections for the lighting element are conventional.

Accordingly, an outlined dispenser recess for a refrigeration appliance or any other appliance can be achieved using the elements disclosed above. The outlining may be illuminated to provide information, aesthetics, safety warning, etc, as desired.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An illuminated dispenser assembly for a consumer appliance panel, the assembly comprising:
a dispenser recess area located in the panel, the dispenser recess area being defined by walls including a bottom wall, two side walls, a back wall and a top wall;
a dispenser located in the panel, the dispenser having an outlet extending through one of the walls of the dispenser recess area to dispense a substance from an interior of the consumer appliance to the dispenser recess via the outlet; and
a lighting element located in the panel for illuminating the dispenser recess, the lighting element including at least one light source and at least one light pipe for transmitting light from the light source to the dispenser recess.

2. The assembly of claim 1, wherein the at least one light pipe outlines an exterior of the dispenser recess.

3. The assembly of claim 1, wherein the at least one light pipe includes two light pipes.

4. The assembly of claim 3, wherein the light source is located adjacent a central area of the top wall and each light pipe extends at least from the light source across a respective front portion of the top wall and down a front portion of a respective one of the side walls.

5. The assembly of claim 1, further including a controller for placing the light source in either a first state or in a second state.

6. The assembly of claim 5, wherein the controller causes the light source to be in the first state if the dispenser is idle and the second state if the dispenser is in operation.

7. The assembly of claim 5, wherein the first state is non-illumination and the second state is illumination.

8. The assembly of claim 5, wherein the first state is illumination with a first color and the second state is illumination with a second color.

9. The assembly of claim 8, wherein the first color corresponds to a first temperature of the dispensed substance and the second color corresponds to a second temperature of the dispensed substance.

10. The assembly of claim 5, where the first state corresponds to a first time of day and the second state corresponds to a second time of day.

11. The assembly of claim 5, further including a user input device in communication with the controller for generating a signal based on input from the user as to a desired dispensed substance, the controller causing the light source to go from the first state to the second state based on the signal from the user input device.

12. An illuminated hot and cold water dispenser assembly for an appliance door, the assembly comprising:
a dispenser recess area located in the door, the dispenser recess area being defined by walls including a bottom wall, two side walls, a back wall and a top wall;
a dispenser located in the door, the dispenser having an outlet extending through one of the walls of the dispenser recess area to dispense a substance from an interior of the door to the dispenser recess via the outlet;
a lighting element located in the door for illuminating the dispenser recess, the lighting element including at least one light source and at least one light pipe for transmitting light from the light source to the dispenser recess; and
a controller for illuminating the light source in either a first color or a second color, the first color corresponding to a first temperature of the dispensed substance and the second color corresponding to a second color of the dispensed substance.

13. The assembly of claim 12, wherein the at least one light pipe outlines an exterior of the dispenser recess.

14. The assembly of claim 12, further including a user input device in communication with the controller for generating a signal based on input from the user as to a desired dispensed substance, the controller causing the light source to illuminate in either the first color of the second color based on the signal from the user input device.

15. The assembly of claim 12, wherein the first color is red and the second color is blue, and wherein the first temperature is hot and the second temperature is cold relative to one another.

16. A refrigeration appliance comprising:
a refrigerated compartment having a door;
a dispenser recess area located in the door, the dispenser recess area being defined by walls including a bottom wall, two side walls, a back wall and a top wall;
a dispenser located in the door, the dispenser having an outlet extending through one of the walls of the dispenser recess area to dispense a substance from an interior of the door to the dispenser recess via the outlet; and
a lighting element located in the door for illuminating the dispenser recess, the lighting element including at least one light source and at least one light pipe for transmitting light from the light source to the dispenser recess.

17. The refrigeration appliance of claim 16, wherein the at least one light pipe outlines an exterior of the dispenser recess.

18. The refrigeration appliance of claim 16, wherein a controller causes the light source to be in a first state if the dispenser is idle and a second state if the dispenser is in operation.

19. The refrigeration appliance of claim 18, further including a user input device in communication with the controller for generating a signal based on input from the user as to a desired dispensed substance, the controller causing the light source to go from the first state to the second state based on the signal from the user input device.
